(19) United States
(12) Patent Application Publication
(10) Pub. No.: US 2013/0041480 A1
(43) Pub. Date: Feb. 14, 2013

(54) METHOD FOR THE REPRESENTATION OF A PROGRAMMABLE SEQUENCE FOR ONE OR MORE MACHINES WITH A CYCLICALLY RECURRING MACHINE OPERATING SEQUENCE

(71) Applicants: Daniel Müller, Kaltbrunn (CH); Erich Knobel, Horgen (CH)

(72) Inventors: Daniel Müller, Kaltbrunn (CH); Erich Knobel, Horgen (CH)

(73) Assignee: NETSTAL MASCHINEN AG, Naefels (CH)

(21) Appl. No.: 13/642,399

(22) PCT Filed: Apr. 20, 2011
(86) PCT No.: PCT/EP2011/056332

§ 371 Date: Oct. 19, 2012

(30) Foreign Application Priority Data
Apr. 28, 2010 (DE) 10 2010 018 475.6

(51) Int. Cl. G05B 11/01

(52) U.S. Cl. 700/23

(57) ABSTRACT

In a method for the representation of the programmable sequence for one or more machines with a cyclic machine sequence on a screen, a sequence is programmed or altered using commands, production parameters are predetermined, actual values for the machine components are determined through the cycle operation and the sequence with the individual process steps and the dependencies thereof are represented on the screen. A chronological correlation of the individual process steps is then produced and is represented on the screen from a fully programmed sequence or partial sequence, taking into consideration the predetermined production parameters and the actual values for the machine components.

The present invention relates to a method for the representation of a programmable sequence for one or more machines according to the introductory clause of claim 1.

In modern machine tools, for example injection moulding machines, machine sequences, for example the production sequence, can often be represented and modelled graphically on a screen facility. With the aid of such a graphic modelling, it is possible in particular to visualize the dependencies between the individual command functions and to make the cyclic sequence as a whole comprehensible to the operator. The individual process steps are partially also animated graphically here during the ongoing machine operation, so that one can monitor and follow on the screen facility the program steps which have just been carried out.

The possibilities of such a modelling help on the one hand in the setting up and reprogramming of a machine tool, for example an injection moulding machine. A finished modelled sequence also shows, however, on the other hand the sequential arrangement provisions very well. However, the chronological correlations are often not represented with sufficient informative value. This is a problem, because often great importance is accorded to the chronological behaviour in a machine sequence with regard to the optimization of a cycle. If such a visualization of the chronological correlation of command functions is absent, then the machine operator, on observing the sequence, must carry out a kind of “intellectual translation task” with respect to the real machine movements or respectively the duration thereof. Thus, a “translation task” is necessary when the findings from a chronological representation (e.g. sequence diagram) must be converted into adaptations on the sequence. Also vice versa, i.e. when for adaptations on the sequence the effects on the chronological behaviour must be appraised, such a transfer task is to be carried out.

With regard to the general background technologies concerning the prior art, reference is to be made to the documents DE 102 469 25 A1, EP 573 912 B1 and WO 2006/089451. In all the above-mentioned cases, it is possible to graphically simulate the sequence in an injection moulding machine and to define it as a function of the individual process steps. If, however, the chronological behaviour of the real cycle is concerned, then the machine operator always has to carry out the above-mentioned “translation task”. This can be explained with the aid of FIGS. 2-4.

In FIG. 2 a sequence representation is shown on a screen facility 10, in which command functions which are to be carried out are represented in the correct sequential arrangement by means of so-called “icons”, and the sequences (also branches) are indicated by means of arrows. The observer can thereby establish the command functions which are to be carried out or which have been carried out. In addition, to a certain extent in addition parallel sequences can be detected. However, a precise chronological correlation can not be seen. For example, in the sequence representation of FIG. 2 the impression is aroused that the functions designated by A and B will elapse simultaneously and parallel. However, a chronological relation of the process steps A and B does not exist. If it were thus assumed, then it would thus be incorrectly interpreted.

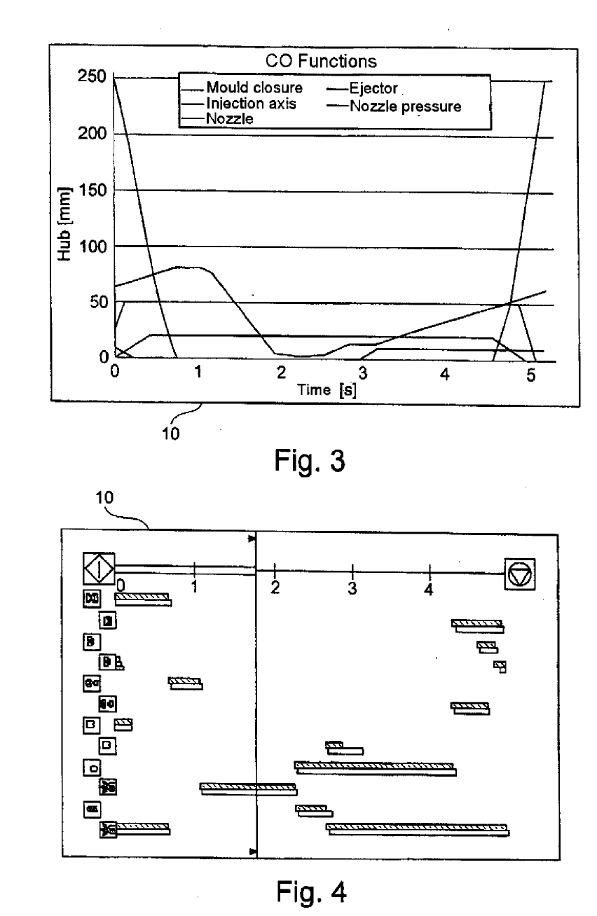

If one represents the cyclic sequence in the form of a so-called CO function (CO derives from Cathode ray Oscilloscope), then in FIG. 3 the chronological courses of the axis positions are issued for the machine components “mould closure”, “injection axis”, “nozzle”, “ejector” and “nozzle pressure”. However, in this representation the structural composition of the sequence program can not be seen, also the relationship of the lines to the associated process step can not be seen directly.

From the so-called sequence graphic (also designated cycle time diagram) in FIG. 4, indeed the chronological sequence of the individual components can be seen, but again the structural composition of the sequence and the dependencies between the individual process steps can not be seen.

It is an object of the present invention to indicate a method which alongside the graphic modelling of a machine operating sequence by indicating the command functions which are to be carried out with the dependencies thereof, in addition represents the chronological behaviour of the machine operating sequence in the correct manner.

This problem is solved by the features named in claim 1.

Accordingly, an idea of the present invention is to be seen in generating a chronological correlation of the individual process steps and representing them on the screen from a fully programmed sequence or also from only a partial sequence for a machine (for example an injection moulding machine), taking into consideration the predetermined production parameters and actual values for the machine components which are used. Thereby, in particular the aforementioned described “translation-” and transfer tasks, which must otherwise be carried out by the operator, are unnecessary. The chronological representation is oriented here strongly to the representation of the graphically modelled cycle.

In this procedure, it is necessary to have complete knowledge of a sequence or partial sequence, because only with knowledge of the corresponding entirety of the command functions and the chronological extent thereof is the chronological effect on one another and for the entire machine operating sequence able to be determined as a whole. Moreover, the necessary production parameters, in particular those which have a chronological influence on the machine operating sequence, are to be predetermined by the operator; for example, it can be important to know at what temperature a process step is to be carried out. Thus, of course, a chronological difference results, whether an axis (e.g. the injection axis) must be moved at a speed of 50 mm/s, 200 mm/s or 450 mm/s. Moreover, a dosing process can be carried out in a shorter or a longer time interval. This depends, in turn, on the speed of revolution of the melt worm, on the material, etc. Also during the moving of movable clamping plates, the operating of the ejector or other actuations often the mode of operation thereof is able to be selected within wide ranges. To determine the relevant actual values, the programmed machine sequence is to be run through (at least) once in the cycle. In particular, the actual values of machine components, which are necessary for the determining of chronological effects are to be simulated; thus, particular actual values of machine components must sometimes be obligatorily maintained, and sometimes are at least time-determining.

For the operator, it is therefore no longer necessary to carry out a “translation task” with regard to a real machine movement, because the chronological correlation is already represented on the screen facility and is thereby explicitly indicated.

The commands are preferably scaled here with regard to length in accordance with the chronological extent and are represented in a chronologically correct length. This can take place for example such that at the start of a command, which is represented in particular in terms of a bar, a command icon is indicated, which indicates the function and subsequently is continued up to the reaching of the chronologically correct end and then terminates. Thereby, from the diagram and the illustration on the screen, one can readily gather the chronological extent and in particular the chronological correlation of the command functions with one another, so that it is clearly apparent which process steps run parallel and which process steps run sequentially.

Also in a preferable embodiment, buffer times which do not enter directly into the cycle time, are therefore not relevant with respect to the cycle time and remain as unused time with regard to the cycle time, can be represented separately.

Moreover, it can be expedient for the operator if the command sequence determining the cycle time is represented as a whole as a critical path. Thereby, he sees which functions and commands are critical for the cycle time resulting from the sequence and what effect it would have if one were to alter particular command functions or to realize them in an alternative manner.

If a progress line is displayed with respect to the diagram on the screen, which indicates the position at which the machine is currently situated during the execution of the sequence program, then the operator can immediately detect by viewing the screen the operating position in which the machine is currently situated and what time has already elapsed since the start of the cycle. Furthermore, he can detect which further commands and functions must still be carried out during the remaining cycle. This type of view is designated the progress mode.

A dedicated viewing possibility consists in realizing a so-called rolling mode, in which the current sequence position is represented locally in a fixed manner on the screen. Under the fixed marking, the sequence program rolls, as it were, in accordance with the execution for example in the form of a band which runs from one side to the other side over the screen. This type of representation is helpful in a continuous operation of the machine. Of course, provision can also be made to switch over between the various types of view.

For a user, moreover, the time between two different command functions can be of interest. For this purpose, it is possible to provide a function in which he marks two sequence points on the screen, wherein the time elapsing between these points is then displayed during the operation of the machine. This is possible, because the sequence and in particular the commands are represented true to timescale. The latter statement also constitutes a core idea of the invention.

Furthermore, the user can arrange to have preceding cycles or else reference cycles displayed. This can of course take place in enlarged or reduced form (scaling—i.e. compression or extension of the lengths and hence also of the time axis).

According to a further advantageous embodiment of the invention, one sequential arrangement of a sequence or an entire sequence with and without reference cycles—for example for a further analysis—is exported, for a programming of a control arrangement is imported into the latter or is stored for a later further use.

The present invention is explained in further detail below with reference to the enclosed drawings with the aid of a practical embodiment. The drawings show in

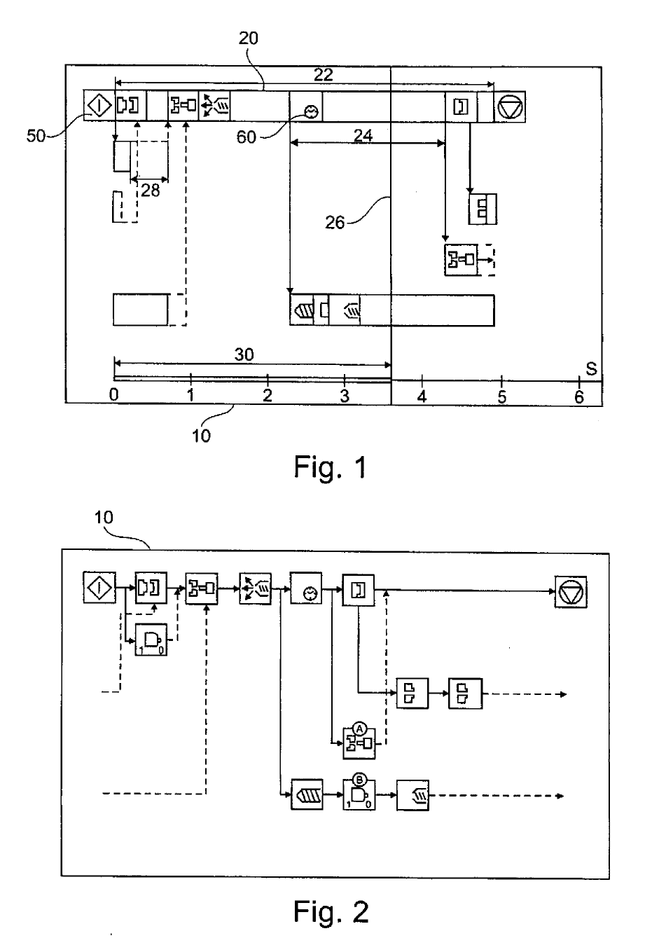

FIG. 1 a diagrammatic illustration of a screen with sequence diagram with exact chronological correlation of the programmed command functions,

FIG. 2 a sequence diagram with dependencies of the command functions without chronological correlation,

FIG. 3 a sequence diagram in the manner of a CO display, and

FIG. 4 a diagram in the manner of a sequence graphic, from which the chronological sequence can be seen, but not the structural composition and the dependencies between the individual process steps.

The example embodiment of the present invention is to be explained solely in view of FIG. 1. Here in FIG. 1, a screen facility 10 is illustrated, on which the operating- and production sequence in the injection moulding machine is illustrated.

The start of an injection moulding cycle is indicated by the icon 50. The icon 52 indicates the end of an injection moulding cycle. When this sequence has been run through, the process begins again at the start of the cycle (icon 50). Between these two markings (icon 50 and 52), the entire sequence of a cycle is modelled in chronologically correct correlations of the command functions to one another. Here, the individual process steps are represented in the form of the command functions. Each command function has a bar, at the start of which a command icon is situated, which indicates the function, and which is extended by means of a bar up to the (chronological) end of the process step.

Thereby, one can detect from the above cohesive line representation that during operation of the injection moulding machine an injection moulding tool is initially closed (icon with reference number 54). Subsequently, the plasticizing- and injecting unit is brought up to the tool (icon with reference number 56) and the injecting- and holding pressure process is carried out (icon with reference number 58). Next, a cooling process is carried out (icon with reference number 60), which extends up to a time at which the tool is opened (icon with reference number 62). In parallel (and illustrated there beneath in FIG. 1), in addition further steps (not designated specifically with reference numbers) are carried out, such as the worm retraction, the opening of the plasticizing nozzle, the dosing of a plastic melt, the raising of the plasticizing- and injecting device from the tool and the operation of the ejector. These steps are represented in parallel with a corresponding dependence branch. Here, attention is paid to the correct chronological correlation, which is now represented in the correct manner, which can be recognized over the time axis (at the bottom in the image).

By superimposing a progress line 26, one can now immediately detect the process step in which the injection moulding machine is currently situated. In the step illustrated in FIG. 1, the cooling time is currently taking place in the tool after the holding pressure, and at the same time the plasticizing- and injecting unit (cf. lower bar) is again currently dosing plastic melt. According to the sequence progress, the progress line 26 travels either over the screen facility (progress mode) or alternatively it remains fixed and the other representation moves under the progress marking from right to left (rolling mode).

From FIG. 1 also with the information 22 the chronological extent of the entire cycle is indicated, wherein the cycle time is determined by the so-called (time-) critical path 20, which contains the command sequence determining the cycle time. This critical path enables the operator to detect the command functions which are determinative for the cycle time. He can alter the cycle time by an alteration of these command functions.

In addition, in the illustration a time period is indicated by reference number 28, which serves as a buffer. In the present case, a free time phase 28, which does not influence the cycle time and therefore constitutes a buffer period, exists between the end of the represented command function and the step at which this function must be terminated before another command function, for example the start of bringing the plasticizing- and injecting device up to the tool (reference number 56).

From the illustration in FIG. 1 one can, in addition, detect the time (cf. reference number 30), which has elapsed between the start of the cycle and the current sequence position. With the present invention, it is also possible to read the time of a particular command, for example the cooling command 60 with the chronological extent 24. Alternatively, it is possible to determine a period of time between two points by two markings in the diagram.

As a whole, therefore, the graphically modelled sequence can be represented in a chronologically correctly scaled manner, wherein also the command sequence determining the cycle time can be seen. On the basis of the progress display, the current machine sequence position can be detected. Of course, it is possible in addition to stop the recording, to enlarge or reduce the representation (zoom functions). Also, other sequences, such as the preceding cycle, a reference cycle etc., can be represented. Moreover, it is possible to alter the configuration of the graphic, for example to select whether only the current cycle or the current cycle and also the preceding cycle or a reference cycle in parallel are to be represented.

In addition, it is possible to export, import or store the sequences of the sequential arrangements—if applicable including predetermined actual values and parameter values and of a reference cycle—, in order to thus enable an analysis, a storage in a control unit or a saving for a later purpose.

The described invention enables the operator to readily set the machine in a simple manner or to monitor the machine sequence, wherein he can immediately detect the chronological correlation between the predetermined command functions. He thereby sees which process steps are running in a staggered manner or simultaneously. A translation task from a modelled sequence control to a real machine movement or of a sequence diagram is thereby no longer necessary.

### LIST OF REFERENCE NUMBERS

10 screen
20 critical path (command sequence determining cycle time)
22 cycle length
24 command length
26 progress indicator
28 buffer time
30 elapsed cycle time

1.-15. (canceled)

16. A method for representing on a display screen a program sequence for at least one machine with a cyclic machine operating sequence having a cycle time, the method comprising the steps of:
programming or altering a sequence using command functions, wherein commands of the command functions are chronologically scaled and are represented with a chronologically correct length,
define production parameters,
incorporating actual values for the machine components,
producing a chronological correlation of the individual process steps from a completely programmed sequence or a partial sequence, taking into consideration the defined production parameters and the actual values for the machine components,
representing a sequence of the individual process steps and the dependencies and chronological correlation of the individual process steps on the display screen, and
displaying a progress line, which indicates a position at which the at least one machine is currently situated during execution of the program sequence.

17. The method of claim 16, wherein the commands of the command functions are represented by a representation of the commands and an extension up to time when a chronologically correct end is reached.

18. The method of claim 16, wherein a buffer time that is not part of the cycle time is represented separately.

19. The method of claim 16, wherein a command sequence determining the cycle time is represented as a critical path.

20. The method of claim 16, wherein an elapsed time between a cycle start and a current position in the program sequence is represented.

21. The method of claim 20, wherein a view is rendered on the display screen in form of a rolling mode, in which a current sequence position is represented in a locally stationary manner and the program sequence is displayed on the display screen in form of a band forming a background commensurate with the execution of the program sequence.

22. The method of claim 21, wherein a view is rendered on the display screen in form of a progress mode, which displays further commands and functions still to be executed in a remaining cycle.

23. The method of claim 16, wherein a time between two points in a sequence is determined from two corresponding points marked on the display screen.

24. The method of claim 16, wherein a cycle sequence preceding a current cycle is indicated.

25. The method of claim 16, wherein a reference cycle sequence is indicated.

26. The method of claim 16, wherein a time axis of the representation is scaled.

27. The method of claim 16, wherein a sequence or sequential arrangements of a sequence are exported, imported or stored.

28. The method of claim 27, wherein the sequence or sequential arrangements are exported, imported or stored with values selected from actual values and reference values.

29. The method of claim 21, wherein a continuous movement of the band can be stopped.
